(19) United States
(12) Patent Application Publication
(10) Pub. No.: US 2008/0126193 A1
(43) Pub. Date: May 29, 2008

(54) AD DELIVERY AND IMPLEMENTATION SYSTEM

(75) Inventor: Andrew Robinson, Apple Valley, MN (US)

Correspondence Address: FOGG & POWERS LLC, 10 SOUTH FIFTH STREET, SUITE 1000, MINNEAPOLIS, MN, 55402, US

(73) Assignee: GROCERY SHOPPING NETWORK, Minneapolis, MN (US)

(21) Appl. No.: 11/563,525

(22) Filed: Nov. 27, 2006

(51) Int. Cl. G06Q 30/00

(52) U.S. Cl. 705/14

(57) ABSTRACT

An ad delivery and implementation system is provided. One method includes attaching a unique identifier to a brand ad. Providing the brand ad to be displayed on a graphic user interface (GUI). Upon selection of the brand ad, reading the unique identifier and identifying the brand ad by reading the unique identifier.

### BACKGROUND

As consumers are becoming more and more computer savvy, ads provided to consumers via a graphic user interface (GUI) are becoming a popular way to inform consumers of products a retailer has to offer for sale. The ability to present the ads in a manner that is easy to manipulate and understand is desired. One method of advertising by a producer of a product is by providing a link via a brand ad on a retailer's web site. When the brand ad is selected (clicked) the user is directed to the producers web page that describes products associated with the brand ad. Hence, the brand ad takes the operator away from the retailer's display screen (or web page) the producer's web page. In this arrangement, the consumer is required to return back to the retailer's web site to select an item to be placed in a shopping list.

For the reasons stated above and for other reasons stated below which will become apparent to those skilled in the art upon reading and understanding the present specification, there is a need in the art for a method of delivering and tracking ads in an effective an efficient manner.

### SUMMARY OF INVENTION

The above-mentioned problems of current systems are addressed by embodiments of the present invention and will be understood by reading and studying the following specification. The following summaries of embodiments are made by way of example and not by way of limitation. They are merely provided to aid the reader in understanding some of the aspects of the invention.

In one embodiment, a method of digital advertising is provided. The method includes attaching a unique identifier to a brand ad. Providing the brand ad to be displayed on a graphic user interface (GUI). Upon selection of the brand ad, reading the unique identifier and identifying the brand ad by reading the unique identifier.

In another embodiment, a method of providing ad information is provided. The method includes associating product ads to products. Associating brand ads to the product ads, wherein each brand ad has a relationship to at least one of the product ads. Attaching a unique identifier to the brand ads. Displaying select product ads and associated brand ads on a graphic user interface (GUI). Upon selection of a brand ad, reading the unique identifier and based on the reading of the unique identifier, placing a product associated with the brand ad in a shopping list.

In yet another embodiment, an ad delivery system is provided. The delivery system includes an ad server. The ad server is configured to categorize products and associate product ads to the categorized products. The ad server is further configured to create relationships between the product ads and brand ads. Moreover, the ad server is further yet configured to attach a unique identifier to each brand ad and read said unique identifier when a brand ad is selected from a graphic user interface (GUI).

### BRIEF DESCRIPTION OF THE DRAWINGS

The present invention can be more easily understood and further advantages and uses thereof more readily apparent, when considered in view of the detailed description and the following figures in which:

FIG. 1 is a block diagram of ad system of one embodiment of the present invention;

FIG. 2 is a product-brand ad association flow diagram of one embodiment of the present invention;

FIG. 3 is a categorization flow diagram one embodiment of the present invention;

FIG. 4 is an ad implementation flow diagram of one embodiment of the present invention;

FIG. 5 is brand ad flow chart of one embodiment of the present invention;

FIG. 6 is an ad-brand ad relationship flow chart of one embodiment of the present invention; and

FIG. 7 is a relationship flow diagram of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

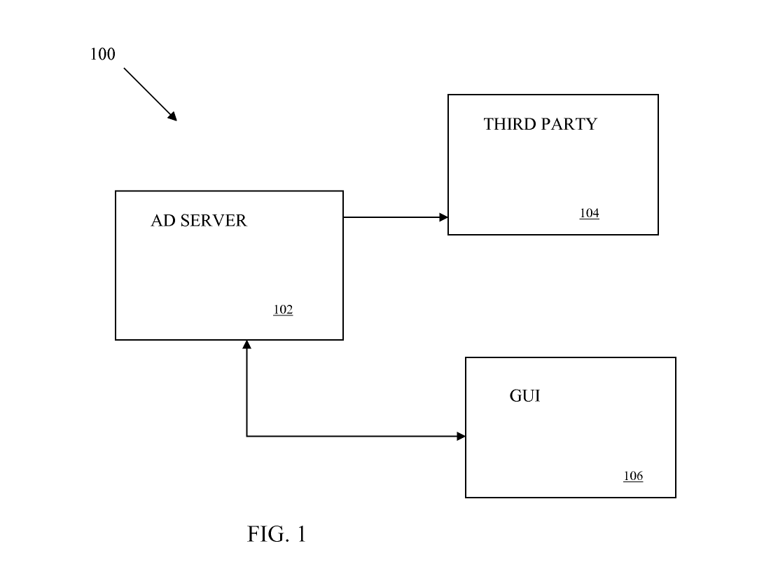

Embodiments of the present invention provide an efficient an improved method of providing ad information as well a method of tracking the selection of brand ads. In one embodiment, a unique identifier made up of a script language is attached to each brand ad. The unique identifier allows for the tracking of a selection of a brand ad. In a further embodiment, the unique identifier allows for the placement of products associated with the brand ad to be directly placed in a shopping list upon selection of the brand ad. Referring to FIG. 1, a block diagram of an ad system 100 of one embodiment of the present invention. As illustrated, the ad system 100 includes an ad server 102 (or ad engine 102), a graphic user interface (GUI) 106 which is generally described as a display 106, and a third party verifier (104). The ad server 102 is designed to provide select advertisements or ads to the display 106. The ads provided by the ad server are in the form of ads of products for sales by the retailer, such as product ads in an ad circular, and brand ads from a producer of a product. Brand ads provided as a link on a display traditionally provide a link to the producer's web page. The producer's web page typically provides related information of products associated with the brand ad. In embodiments of the present invention, the selection of a brand ad results in a related product being placed in a shopping list on the retailer's web site. The third party verifier 104, in one embodiment, provides verification when a brand ad has been selected (or clicked). This verification, in one embodiment, is used to compensate the owner of the ad server.

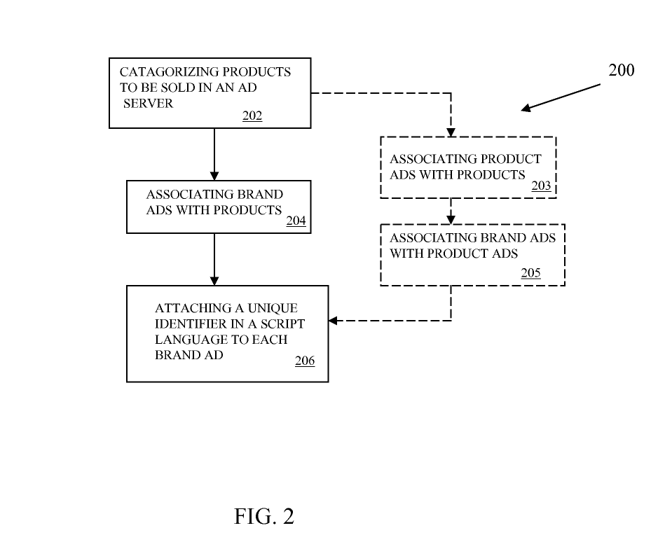

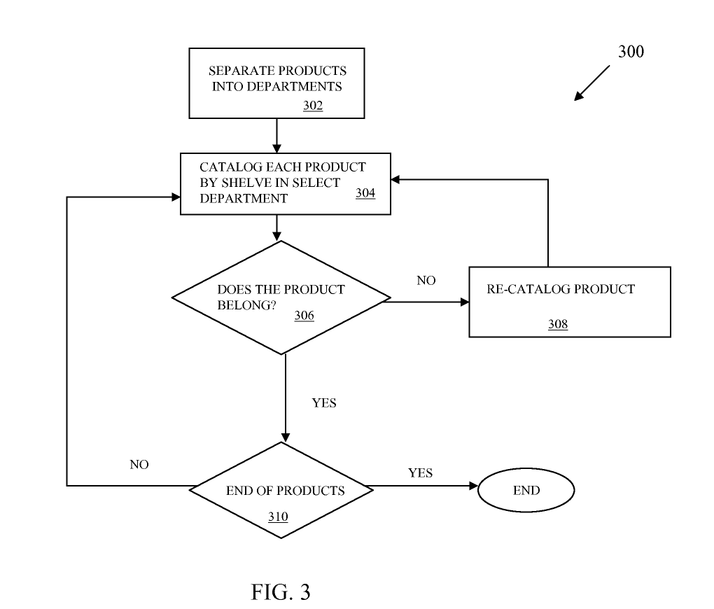

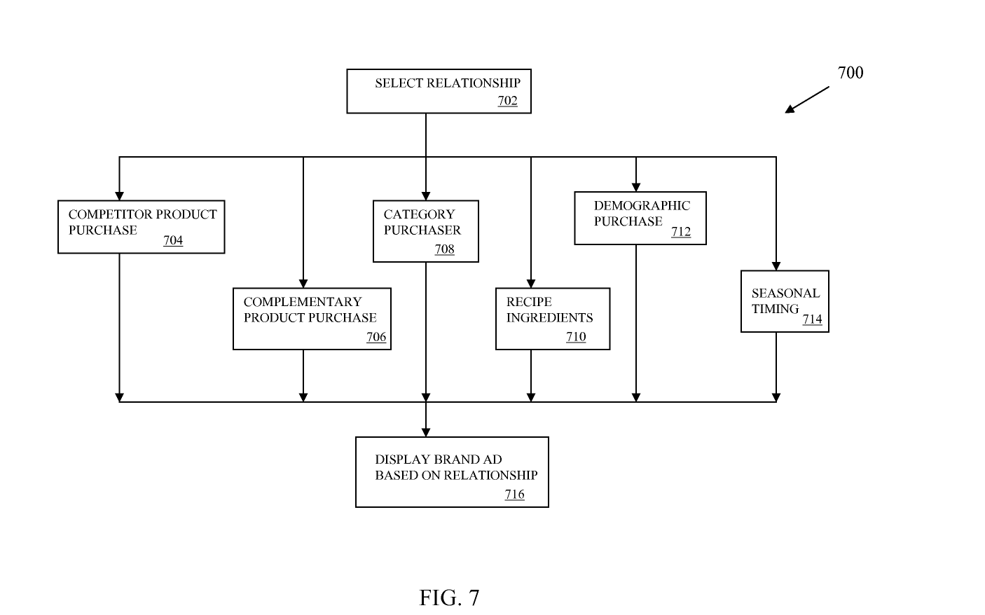

FIG. 2 is a product-brand ad association flow diagram 200 of one embodiment of the present invention. As illustrated, the flow diagram 200 starts by categorizing products to be sold in an ad server (202). An example of an embodiment for categorizing products is illustrated in the flow diagram of FIG. 3. As illustrated in FIG. 2, in one embodiment, the brand ads are associated with the products that have been categorized (204). In another embodiment, product ads 203 (or more generally referred to as ads 203) are first associated with products (203). The brand ads are then associated with the product ads (205). FIG. 7 illustrates one embodiment of brand ad—product-product ad associations 700. Referring back to FIG. 2, a unique identifier in a script language is attached to each brand ad (206). The unique identifier enables tracking of when a brand ad has been selected or clicked.

As discussed above, a categorization flow diagram 300 of one embodiment of the present invention is illustrated in FIG. 3. As illustrated in FIG. 1, in this embodiment, the products are first separated into departments (302). The products are then separated by shelves in designated departments (304). It is then determined if the product belongs in the shelf (306). If the product does not belong (306), it is re-cataloged in different shelf (308). Once all the products have been cataloged (310), the process ends. Otherwise, if not all the products have been categorized (301), the process continues at (304).

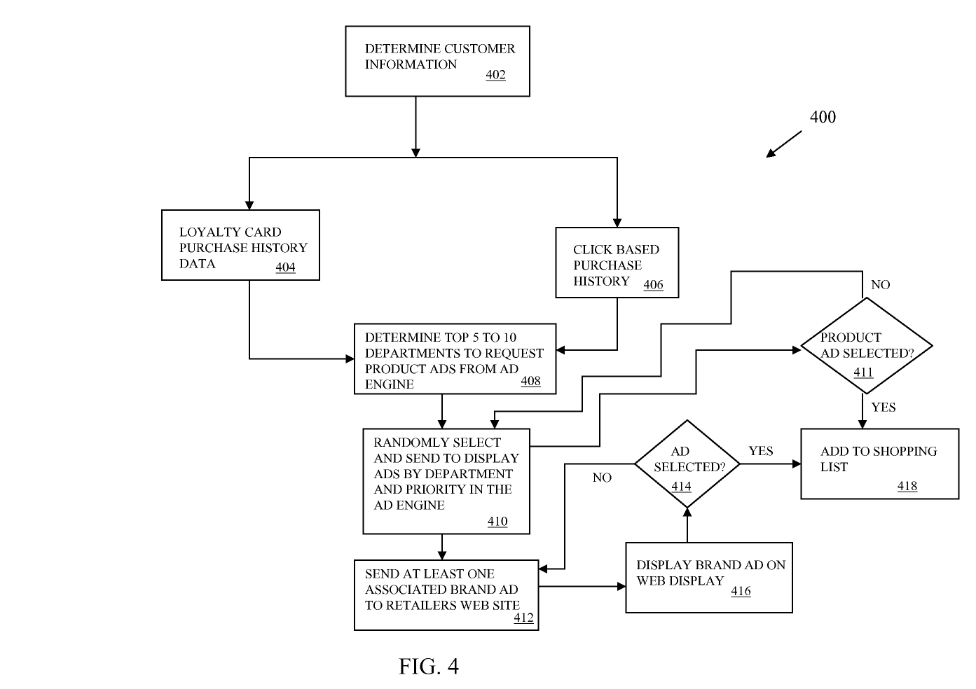

An ad implementation flow diagram 400 of one embodiment of the present invention is illustrated in FIG. 4. As this flow diagram 400 illustrates, information is first determined regarding the customer (402). In the embodiment of FIG. 4, the customer information can be received by either a loyalty card history (404) or a click based history (406). Loyalty card history (404) is based on the tracking of purchases associated with the use of a loyalty card. A click based history (406) is based on the past selection of products via their selection on a web page. Based at least in part on the customer purchase history, 5 or 10 departments in this embodiment are identified (408). In one embodiment, products in the identified departments are randomly selected (410). In another embodiment, products in the selected departments are further provided a score based on the likelihood the consumer would buy the product. A score of a product is based on the customer's past purchase history. In one embodiment, the score of a product is also used to select products ads to be displayed (410). In one embodiment, the ads (or product ads) are displayed in an ad circular format on a retailer's web site. If a product is selected in the ad circular (411), a product identifier is placed in a shopping list (418).

A brand ad associated with a product (or product ad) is then sent to a retailer's web page (412). The brand ad is then displayed on the retailer's website (416). When the brand ad is selected (clicked) a product associated with the brand ad is placed in a shopping list (418). In one embodiment, after a select amount of time has passed and the brand ad has not been selected (414), the process continues at 412 with another brand ad.

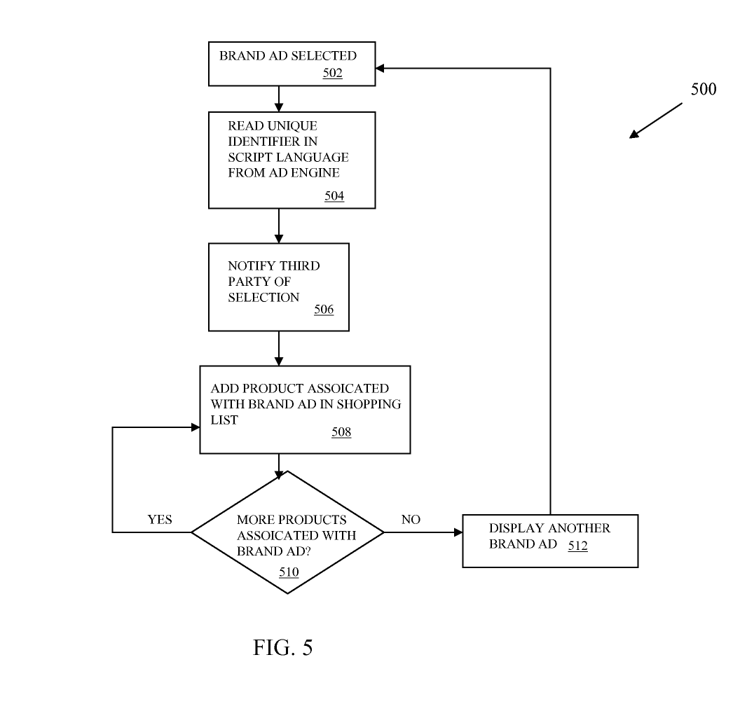

A brand ad flow chart of one embodiment of the present invention is illustrated in FIG. 5. Once a brand ad has been selected (clicked) (502), a unique identifier attached to the brand ad is read (504). In one embodiment the unique identifier is in a script language. Moreover, in one embodiment the script language is Javascript text. An example of Javascript text setup that is attached to a brand ad in on embodiment is as follows:

<a href=”%u” onClick=”clickThru(‘%c’, ‘Department ID’, ‘Brand Name’, ‘Product
Description’, ‘Product Code’, ‘Quantity’, ‘Display Size’, ‘Regular Price’, ‘Current Price’,
‘Savings Amount’, ‘Savings Statement’):”><img src=”%h/1146572/product.gif’
height=’ ’ width=” ” border=” ”alt=” ”></a>

In one embodiment, a third party verifier is then notified that the brand ad has been selected (506). The ability to determine which brand ad has been selected is based on the reading of the unique identifier. The third party verifier can then use this information to, among with other things, notify the producer of how many times the brand ad is selected. This information could then be used to compensate a party providing the ad server (ad engine). As illustrated, in this embodiment, a product associated with the brand ad is then placed in the shopping list (508). Hence, in this embodiment, the activation (selection or clicking) of a brand ad results in an associated product being placed in the shopping list. This is unlike prior systems were an activation of a brand ad would direct the user to the producer's web page. The ability to place a product in the shopping list in response to the selection of brand ad is also based on the unique identifier that allows the ad server to determine the associated product. In the embodiment illustrated in FIG. 5, it is then determined of more products are associated with the brand ad (51 0). If other products are associated with the brand ad (510), they are added to the shopping list (508). If no other products are associated with the brand ad (510) another brand ad is displayed (512).

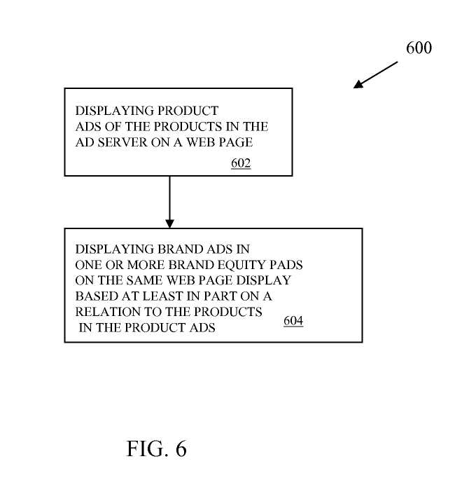

Referring to FIG. 6, an ad-brand ad relationship flow chart 600 of one embodiment of the present invention is provided. As illustrated, products stored in an ad server (or ad engine) are displayed on a web page of a retailer (602). In one embodiment, the product ads are displayed as an ad circular. Moreover, in one embodiment, the ads displayed have some relation to products previously purchased by the consumer visiting the web page of the retailer. Along side of the product ads are displayed one or more brand ads in one or more brand equity ads (604). The brand ads or brand equity ads have some relation to one or more of the product ads displayed in the ad circular.

Possible relationships are illustrated in the relationship flow diagram 700 of FIG. 7. As illustrated, in this embodiment the relationship is selected. The relationship may include a competitor's product purchase (704). With this relationship, a customer's past purchase history is looked at to determine the types of products purchased. Products with different producers are then selected. For example, if the customer has bought a specific brand of orange soft drink in the past, a brand ad for a different producer of an orange soft drink would be related and displayed in a brand ad (716). Another relationship used is the complementary product purchase (706). With this relationship, a product that is typically used with another product is displayed (716). For example, if the ad circular included milk, a complementary product may be a cereal that is displayed as a brand ad (706). Still another relationship is a category purchaser relationship (708). In one embodiment, the relationship looks at the past purchase history of a consumer to determine prior categories of purchase. For example, in this embodiment, if a customer has a history of purchasing pasta, when an ad in a circular includes a pasta item, a brand ad relating to another pasta product would be provided (716).

The relationships could also include recipe ingredients. Hence if a recipe is shown on a display, an associated ad displayed in a brand ad would be an ingredient in the recipe (716). Still another relationship relates to demographic purchase (712). In this relationship, if a customer's past purchase history includes demographic information a related ad is displayed (716). For example, if past purchase history of a customer shows the purchase of diapers, other baby type brad ads would be displayed next to the products ads. Still another relationship is a seasonal timing relationship (714). With this relationship, seasonal items related to ads in a circular are displayed in a brand ad (716). For example, if the season was thanksgiving and a circular displayed turkeys the related brand ad may show a cranberry ad.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of digital advertising:
attaching a unique identifier to a brand ad;
providing the brand ad to be displayed on a graphic user interface (GUI);
upon selection of the brand ad, reading the unique identifier; and
identifying the brand ad by reading the unique identifier.

2. The method of claim 1, further comprising:
reporting the selection of a brand ad to a third party verifier.

3. The method of claim 1, wherein the unique identifier is a script language.

4. The method of claim 1, further comprising placing a product related to the brand ad in a shopping list upon the identification of the brand ad that was selected

5. The method of claim 1, further comprising:
displaying the brand ad with product ads on the GUI, the brand ad having a relationship to at least one of the product ads.

6. The method of claim 5, wherein the relationship between the brand ad and to the at least one of the product ads is at least one of a competitor product purchase, a complementary product purchase, a category purchaser, a recipe ingredient, a demographic purchase and a seasonal timing.

7. The method of claim 5, wherein the product ads displayed are selected based at least in part on the customers past purchase history.

8. A method of providing ad information, the method comprising:
associating product ads to products;
associating brand ads to the product ads, wherein each brand ad has a relationship to at least one of the product ads;
attaching a unique identifier to the brand ads;
displaying select product ads and associated brand ads on a graphic user interface (GUI);
upon selection of a brand ad, reading the unique identifier; and
based on the reading of the unique identifier, placing a product associated with the brand ad in a shopping list.

9. The method of claim 8, further comprising:
based on the reading of the unique identifier, notify a third party verifier of the selection of the brand ad.

10. The method of claim 8, wherein the relationship between the brand ad and product ad is at least one of a competitor product purchase, a complementary product purchase, a category purchaser, a recipe ingredient, a demographic purchase and a seasonal timing.

11. The method of claim 8, wherein displaying select product ads on the GUI further comprises:
selecting product ads based at least in part on a consumers past purchase history.

12. The method of claim 8, further comprising:
cataloging products with an ad server.

13. The method of claim 12, wherein cataloging products further comprises;
separating products into departments;
cataloging products by selves in the departments; and
verify if each product belongs on the shelf.

14. The method of claim 12, wherein the product ads displayed are associated with products selected from a select number of departments determined by the customers past purchase history.

15. An ad delivery system, the system comprising:
an ad server configured to categorize products and associate product ads to the categorized products, the ad server further configured to create relationships between the product ads and brand ads, the ad server further yet configured to attach a unique identifier to each brand ad and read said unique identifier when a brand ad is selected from a graphic user interface (GUI).

16. The ad delivery system of claim 15, wherein the ad server is further in communication with a third party verifier to notify the third party vendor when a unique identifier associated with brand ad is read.

17. The ad delivery system of claim 15, wherein the ad server is further configured to place a product associated with a brand ad in a shopping list when a unique identifier of a brand ad is read.

18. The ad delivery system of claim 15, wherein the ad server is further in communication with a retailer's web site to provide the product ads and brand ads to be displayed on the retailer's web site.

19. The ad delivery system of claim 18, wherein the ad server is configured to provide only brand ads that have a select relationship to at least one of the product ads provided to be displayed on the retailer's web site.

20. The ad delivery system of claim 18, wherein the product ads to be displayed on the retailer's web site are selected by the ad server based at least in part on a customer's past purchase history.
